(19) United States
(12) Patent Application Publication
(10) Pub. No.: US 2013/0140857 A1
(43) Pub. Date: Jun. 6, 2013

(54) Seat Air-Tube Ventillation System

(71) Applicants: Kwangjin Shin, Pike Road, AL (US); Kyuil Kim, Vernon Hills, IL (US); Hyunjae Park, Franklin, WI (US)

(72) Inventors: Kwangjin Shin, Pike Road, AL (US); Kyuil Kim, Vernon Hills, IL (US); Hyunjae Park, Franklin, WI (US)

(21) Appl. No.: 13/688,359

(22) Filed: Nov. 29, 2012

Related U.S. Application Data
(60) Provisional application No. 61/566,206, filed on Dec. 2, 2011.

(51) Int. Cl. B60N 2/56

(52) U.S. Cl. CPC B60N 2/5657
USPC 297/180.13

(57) ABSTRACT

A vehicle seat including a spiral-shaped air-tube seat ventilation system having a seat pad module. The seat pad module includes a foam cushion member, with the cushion member defining a spiral groove. An elongated tube defining a plurality of orifices in fluid communication with the tube interior is disposed in the spiral groove, with a spacer fabric pad and a heating pad coupled to the foam cushion member. One or more of the seat pad modules is then coupled to one or more of the vehicle seat back and the vehicle seat base.

This patent application claims priority of U.S. Provisional Patent Application No. 61/566,206, filed on Dec. 2, 2011, which is entitled “Seat Air-Tube Ventilation System,” which patent application is hereby incorporated herein by reference in its entirety.

### BACKGROUND OF THE INVENTION

Field of the Invention—The present invention relates generally to the field of vehicle seats, and more particularly relates to a vehicle seat including a spiral-shaped air-tube ventilation system.

It is known to provide a vehicle seat, for example an automobile passenger seat, with a heating and ventilating system. Typically such heating and ventilating systems are separately installed. It is also known that existing ventilation seat systems exhibit relatively low performance as a result of an inefficient fan-air delivery system. A typical ventilating system for an automobile seat is configured with interconnecting tubes or channels that generally are orthogonal to each other with a series of parallel tubes or grooves extending from a main trunk. Such configurations typically do not provide balanced air pressure throughout the system which results in inefficient operation. It is also known that in the manufacturing of the automobile seat difficulties occur in maintaining alignment of the air channels with the fabrics, cushions, and related seating elements.

The apparatus of the present disclosure must also be of construction which is both durable and long lasting, and it should also require little or no maintenance to be provided by the user throughout its operating lifetime. In order to enhance the market appeal of the apparatus of the present disclosure, it should also be of inexpensive construction to thereby afford it the broadest possible market. Finally, it is also an objective that all of the aforesaid advantages and objectives be achieved without incurring any substantial relative disadvantage.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

### SUMMARY OF THE INVENTION

The disadvantages and limitations of the background art discussed above are overcome by the present disclosure.

There is provided a vehicle seat including a seat air-tube ventilation system. The vehicle seat includes a seat back and a seat base coupled to a seat frame. The air-tube seat ventilation system includes a seat pad module, a perforated seat cover, and an air moving device.

The seat pad module includes a foam cushion member, with the cushion member defining a spiral groove. An elongated tube is disposed in the spiral groove, with the tube defining a plurality of orifices in fluid communication with the tube interior. A spacer fabric pad is coupled to the foam cushion member and configured to facilitate retention of the elongated tube in the groove. A heating pad is coupled to the spacer fabric. The seat pad module is then coupled to one of the seat back and the seat base.

The perforated seat cover, typically leather, is configured to enclose the seat pad module.

An air moving device, for example a pump or fan is coupled to the seat pad module and is in fluid communication with one end of the elongated tube. In one embodiment the air moving device is disposed beneath the seat frame, typically below the seat base.

In another embodiment, the vehicle seat further includes at least one additional seat pad module coupled to one of the seat back and the seat base, with the one additional seat pad module coupled to the air moving device. In yet another embodiment, the vehicle seat may include two additional seat pad modules such that there are two seat pad modules coupled to the seat back and two seat pad modules coupled to the seat base. Each of the seat back modules are coupled to the air moving device. In some configurations, an additional air moving device is included with one air moving device coupled to each of two of the seat pad modules.

In another embodiment, the elongated tube is configured in the spiral groove with not less than one and one half turns. In another embodiment, the elongated tube is configured in the spiral groove with not more than four turns. In any of the configurations, the plurality of orifices in the elongated tube is not less than five orifices nor more than twenty orifices. The orifices are configured with the perimeter being one of a circle, in ellipse, a triangle, a tear drop, an arrow, a cross, and a rectangle typically determined by the manufacturer of the vehicle seat. It should also be understood that the orifices can be any combination of such orifice perimeters.

In any of the above-described configurations, the elongated tube is configured with a cross section defining a circle, an ellipse, a triangle, and a rectangle. The spiral groove in the foam cushion member in any of the configurations can be configured as one of a circle, a triangle, and a rectangle. The elongated tube can be configured with one end closed and the other end coupled to the air moving device. In another embodiment, the elongated tube has one end configured for recirculation of the fluid moving in the tube with the other end of the elongated tube coupled to the air moving device. Since the elongated tube is configured in a spiral configuration, one end of the elongated tube will be an innermost end of the spiral and the other end of the elongated tube will be the outermost end of the elongated tube. It should be understood that either end, the innermost end or the outermost end of the elongated tube can be coupled to the air moving device. In another embodiment, the elongated tube interior passageway reduces from one end of the tube to another end of the tube.

There is further disclosed a method for providing heating and ventilating to a vehicle seat. The vehicle seat includes a seat base and a seat back both coupled to a seat frame. The method includes installing a seat pad module on one of the seat back and seat base. Each seat pad module includes an air dispensing mechanism and a heat dispensing mechanism. Each seat pad module on the seat back and seat base is covered with a perforated seat cover configured to enclose each seat pad module. An air moving device is coupled to each seat pad module configured to provide air to each seat pad module, wherein air and heat moves through the perforated cover.

Another embodiment of the method for providing heating and ventilating to a vehicle seat provides that each seat pad module includes a foam cushion member, with the cushion member defining a spiral groove. An elongated tube is disposed in the spiral groove, with the tube defining a plurality of orifices in fluid communication with the tube interior. The spacer fabric pad is coupled to the foam cushion member and configured to facilitate retention of the elongated tube in the groove. A heating pad is coupled to the spacer fabric.

The apparatus of the present invention is of a construction which is both durable and long lasting, and which will require little or no maintenance to be provided by the user throughout its operating lifetime. Finally, the vehicle seat air-tube ventilation system and method of the present invention achieves numerous advantages without incurring any substantial relative disadvantage.

### DESCRIPTION OF THE DRAWINGS

These and other advantages of the present disclosure are best understood with reference to the drawings, in which:

FIG. 1 is an exploded perspective view of an exemplary embodiment of a vehicle seat including an exemplary embodiment of a seat air-tube ventilation system of which two seat pad modules for the seat base and two seat pad modules for the seat back are illustrated, and an exploded view of one seat pad module;

FIG. 2 is a partial sectional view of one of the seat pad modules illustrated in FIG. 1;

FIGS. 3A-3D illustrate cross-section variations (circle, triangle, ellipse, and rectangle, respectively), of an elongated tube of the seat pad modules illustrated in FIG. 1;

FIGS. 4A-4E illustrate the various orifice perimeter shapes (circle, triangle, ellipse, rectangle, and tear-drop, respectively), defined in the elongated tube of the seat pad module;

FIG. 5 is a schematic illustration of fluid velocity gradient for fluid flow directed through the interior passageway (into the page) of an elongated tube of the seat pad module;

FIG. 6 is a partial cross-section of a foam cushion member defining a spiral groove with an elongated tube disposed in the spiral groove of a seat pad module illustrated in FIG. 2;

FIG. 7A is an illustration of an exemplary embodiment of the elongated tube configured in a circular spiral for disposition in a spiral groove, with one end of the elongated tube closed, which as illustrated is the innermost end of the elongated tube, and which as illustrated is an elongated tube with slightly more than one and one-half turns;

FIG. 7B is an illustration of an exemplary embodiment of the elongated tube configured in a circular spiral for disposition in a spiral groove, with one end of the elongated tube closed, which as illustrated is the outermost end of the elongated tube, and which as illustrated is an elongated tube with slightly more than one and one-half turns;

FIG. 8A is an illustration of an exemplary embodiment of a circular spiral elongated tube with one end, the innermost end, coupled back into the elongated tube to recycle a fluid flowing through the interior passageway of the tube, and which as illustrated is a two-turn elongated tube;

FIG. 8B is an illustration of an exemplary embodiment of a circular spiral elongated tube with one end, the outermost end, coupled back into the elongated tube to recycle a fluid flowing through the interior passageway of the tube, and which as illustrated is a two-turn elongated tube;

FIG. 9 illustrates an exemplary embodiment of an elongated tube configured in a square spiral for disposition in a corresponding square spiral groove with the innermost end of the tube open and the innermost end of the tube closed; and

FIG. 10 illustrates an exemplary embodiment of an elongated tube configured in a triangular spiral for disposition in a corresponding triangular spiral groove with the innermost end closed and the innermost end open.

### DETAILED DESCRIPTION OF THE EXEMPLARY EMBODIMENTS

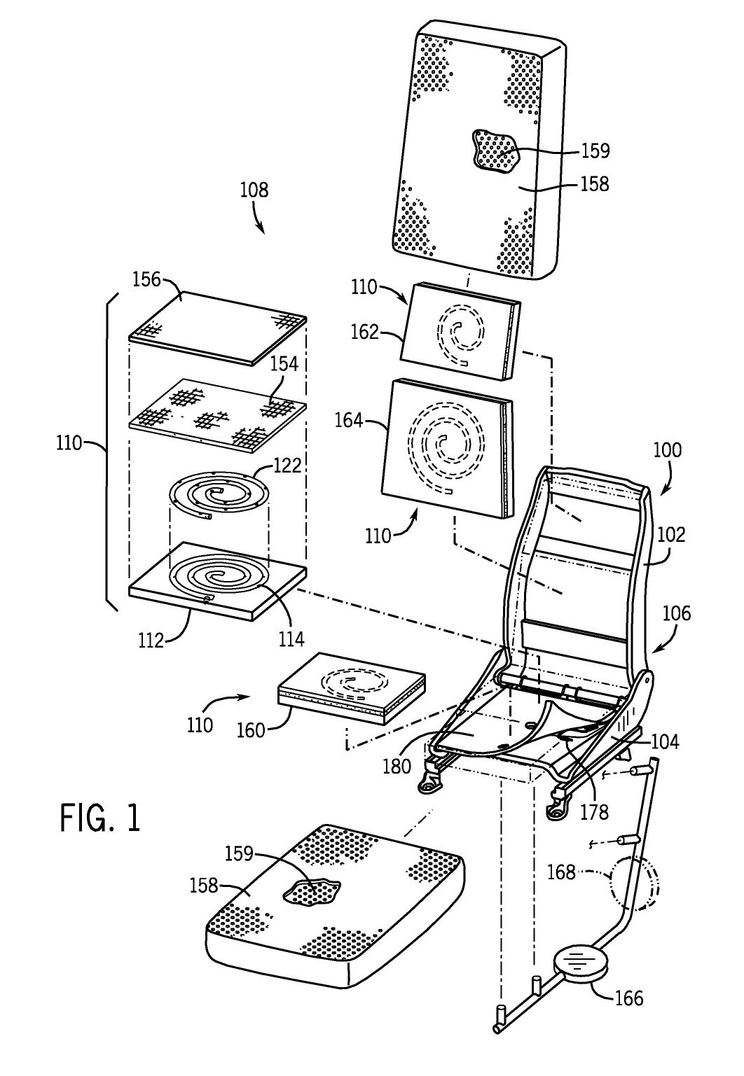

The illustrations, FIGS. 1-10 relate to a seat (can also be referred to as a chair) particularly adapted for motor vehicles, such as automobiles, SUV's, vans, trucks, buses, and the like, but the invention is applicable also to seating used in aircraft, railroad vehicles, nautical vehicles, or other environments. The illustrated seat is a seat of an automobile. The seat may also be configured as a split seat, a captain's chair or a bench-type seat.

The seat illustrated in FIG. 1 is a padded seat having certain contours, trim and the like. It should be understood that a wide variety of seat configurations and appearances will benefit from use of the seat air-tube ventilation system disclosed herein. The exterior of the seat can be covered by fabric, vinyl, leather or other materials known or used in the seating art, with the preferred seat cover being a perforated leather and an associated air permeable foam pad.

It should be understood that the vehicle seat can include certain mechanical systems to move the seat components to achieve certain results, such components and mechanisms, manual or power can be used. For example, four bar linkages, air or hydraulic cylinders, air bladders, rack and pinion systems, cams and cables, gears, etc. could be employed to manipulate the seat as determined by a user of the seat. Such mechanisms, in conjunction with the present disclosure, results in a more comfortable seat for an occupant.

Referring generally to the figures and particularly to FIG. 1, there is shown a vehicle seat 100 including a seat base 104 which supports one or more seat pad modules 110 and a seat back 102 which is also configured to support one or more seat pad modules 110. The seat base 104 and seat back 102 may be pivotally connected to each other. The vehicle seat 100 can be either a manually adjustable seat or may be provided with electric motors to provide automated adjustment and electronic control of the seat. The vehicle seat 100 is typically connected to the floor of a support structure of a vehicle in any of a variety of configurations or design which allow for the movement and adjustment of the vehicle seat 100 within the vehicle. The vehicle seat may optionally include a headrest which may also be adjustable with respect to an occupant of the seat.

As illustrated in FIG. 1 there are two seat pad modules 110 configured to be coupled to a seat back 102 and two seat pad modules 110 configured to couple to the seat base 104. The seat frame 106 also includes a seat spring 178 with a seat spring cushion 180. It should be understood that springs and appropriate spring cushions can also be provided with the seat back 102 to provide additional comfort and support for an occupant of the seat.

FIG. 1 also illustrates a vehicle seat 100 that includes a seat air-tube ventilation system 108. The seat air-tube ventilation system includes a seat pad module 110, a perforated seat cover 158, and an air-moving device 166. In the vehicle seat 100 illustrated in FIG. 1, there are two seat pad modules 110 for the seat back 102 and two seat pad modules 110 for the seat base 104.

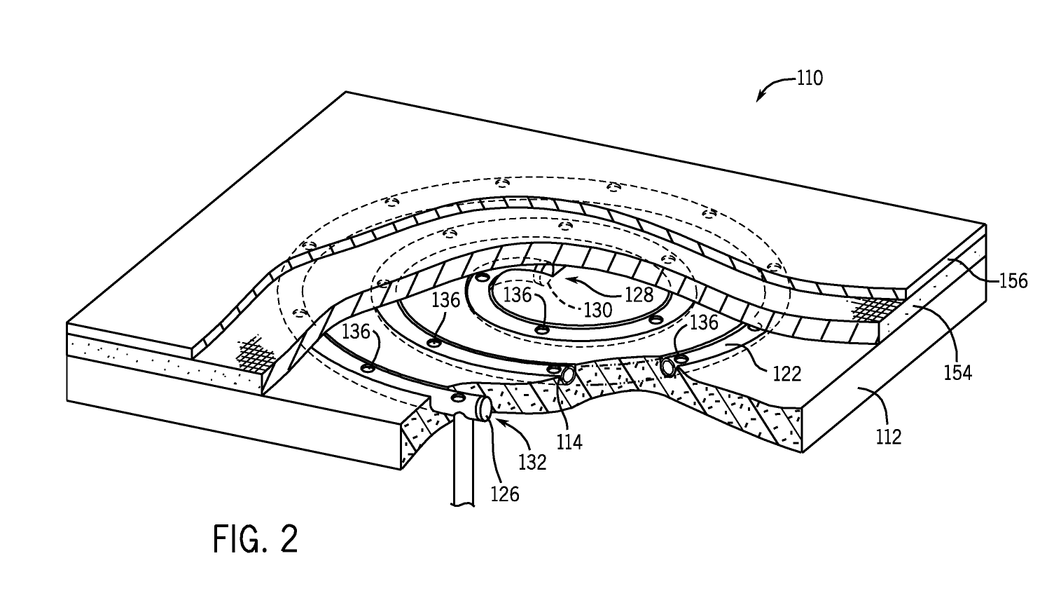

FIGS. 1 and 2 also illustrate the structure of a seat pad module 110. It should be understood that below is a description of a seat pad module 110 and would be the same for any number of seat modules that are employed in a particular vehicle seat. Referring to FIGS. 1 and 2, the seat pad module 110 includes a foam cushion member 112. The cushion member 112 defines a spiral groove 114. The foam cushion member 112 is composed of any suitable foam or cushion material that typically is molded in a given shape appropriate for a vehicle seat. During the molding process, the spiral groove 114 is formed in the cushion.

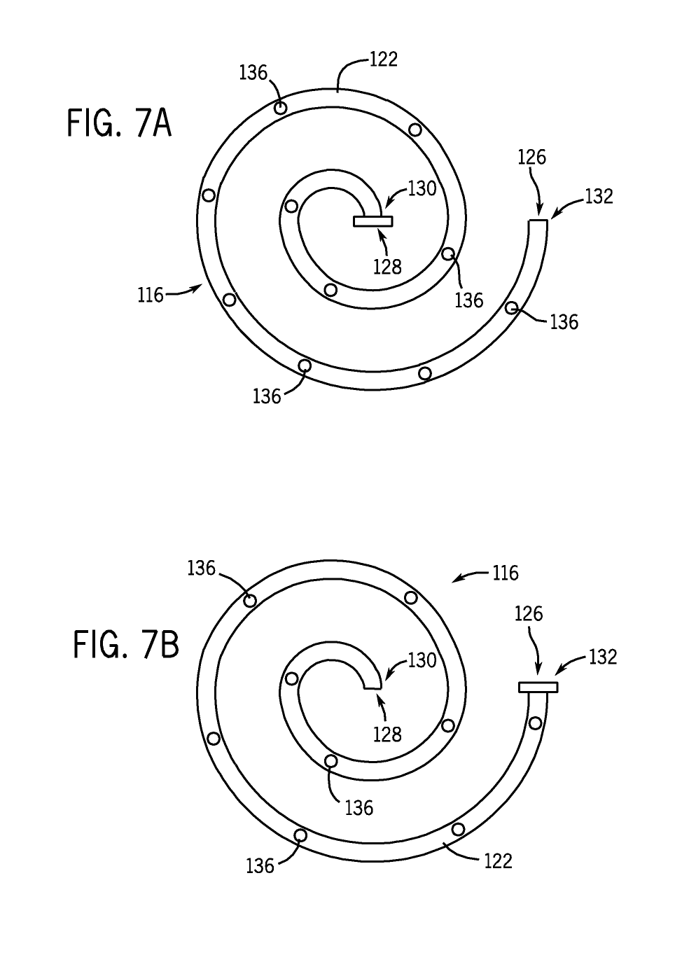

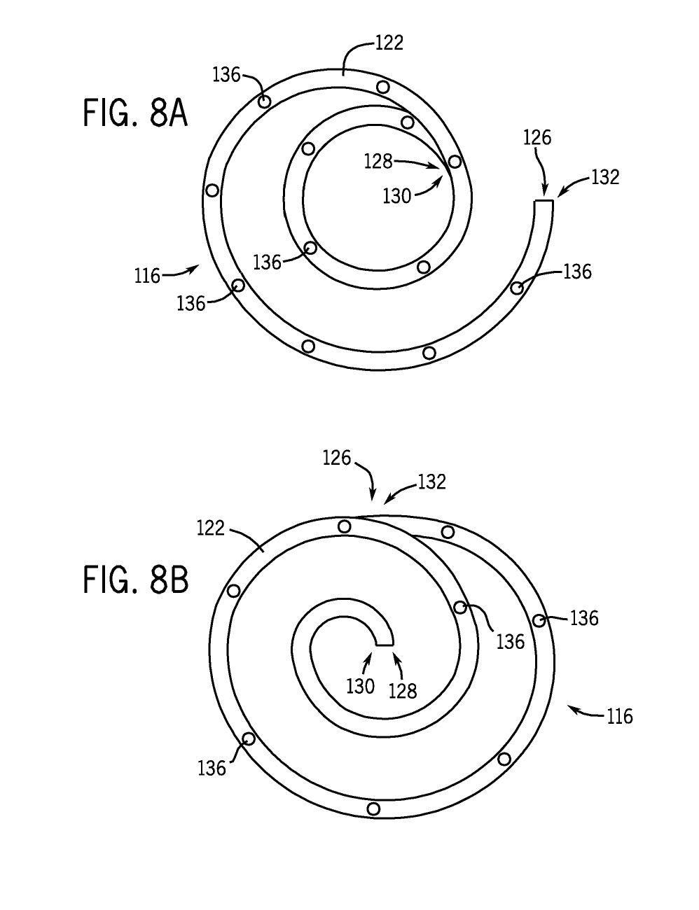

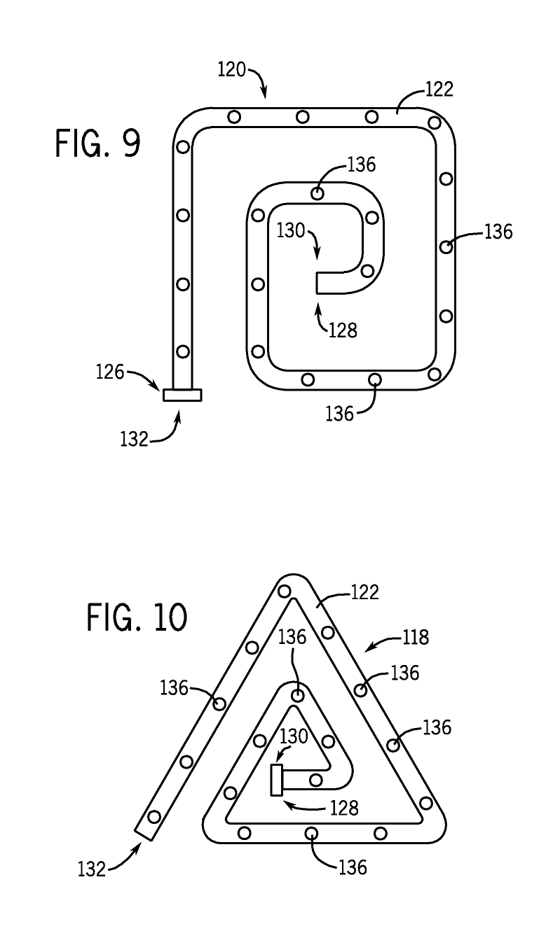

Alternatively, the spiral groove 114 can be cut into the foam cushion by any convenient method, for example a hot wire cutter. As illustrated in FIGS. 7A-10, the spiral groove 114 can be configured in a substantially circular pattern 116 (FIGS. 7A, 7B, 8A, and 8B), a substantially rectangular pattern 120 (FIG. 9), or a triangular pattern 118 (FIG. 10). It should be understood that the illustrated pattern are of the elongated tube 122 that will be disposed in a corresponding spiral groove 114 (See FIGS. 2 and 6).

The elongated tube 122 is disposed in the spiral groove 114, with the tube defining a plurality of orifices 136 which are in fluid communication with the tube interior 134. It is contemplated that each seat pad module 110 will include an elongated tube 122 disposed in a spiral groove 114. The number of coil turns are a minimum of one and one-half turns to a maximum of four turns per coil. FIGS. 7A and 7B illustrate little more than one and one-half turns of the coil. FIGS. 8A and 8B illustrate a two-turn coil. FIG. 1 illustrates a two and one-half turn coil of the elongated tube 122.

The orifices 136 are defined in the elongated tube 112 by the perimeter 138 of each orifice 136. The perimeter 138 of an orifice 136 in the air-tube ventilation system 108 typically is configured as one of a circle 140, an ellipse 142, a triangle 144, a rectangle 146, and a tear-drop 148 as illustrated in FIGS. 4A-4E. It is also contemplated that an arrow shaped or cross shaped orifice can be defined in the elongated tube 122 as determined by manufacturer of the air-tube ventilation system 108. It is also contemplated that any combination of such orifice perimeters can be utilized for a given vehicle seat configuration.

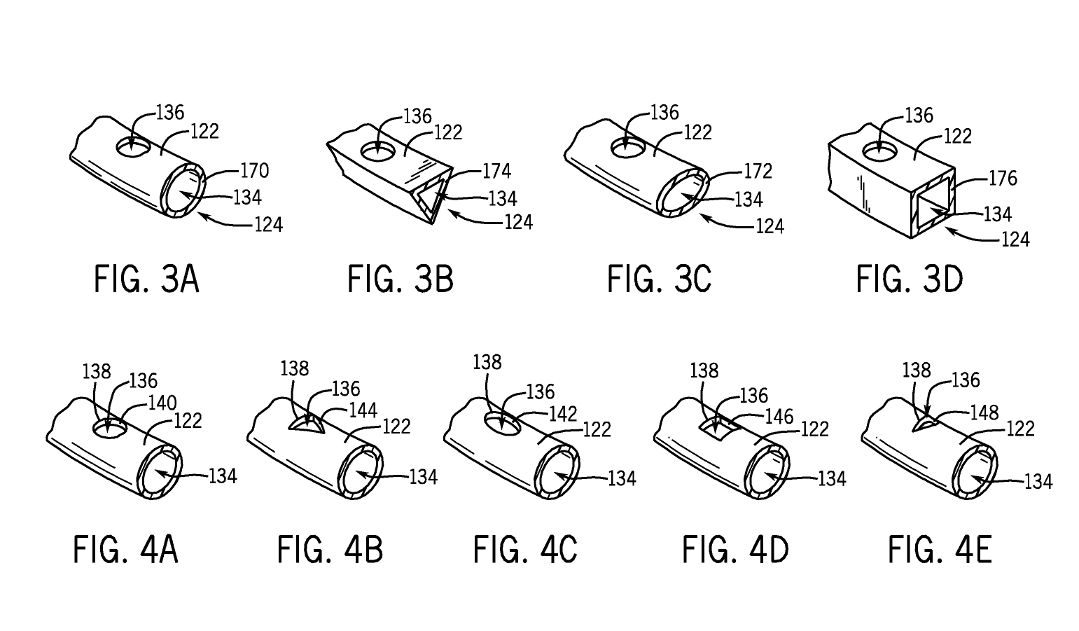

The elongated tube 122 can be configured with a cross section 124 from a group consisting of a circular cross section 170, an ellipse cross section 172, a triangular cross section 174, and a rectangular cross section 176. (See FIGS. 3A-3D). It should be understood that the contour of the spiral groove 114 will correspond to the particular cross section of the elongated tube 122 as determined by the manufacturer of the air-tube ventilation system 108.

Each elongated tube 122 defines one end 126 and another end 130. One of each of those ends will be an innermost end 128 and an innermost end 132 of each elongated tube 122 configured in the spiral configuration discussed above. The coupling to an air moving device 166 can occur at either the innermost end 128 or the innermost end 132 of a specific elongated tube 122. FIGS. 7A, 8A, and 10 are configured for coupling to an air moving device 166 at the innermost end of the elongated tube. FIGS. 7B, 8B, and 9 is configured to couple to an air moving device 166 at the innermost end 128 of the elongated tube.

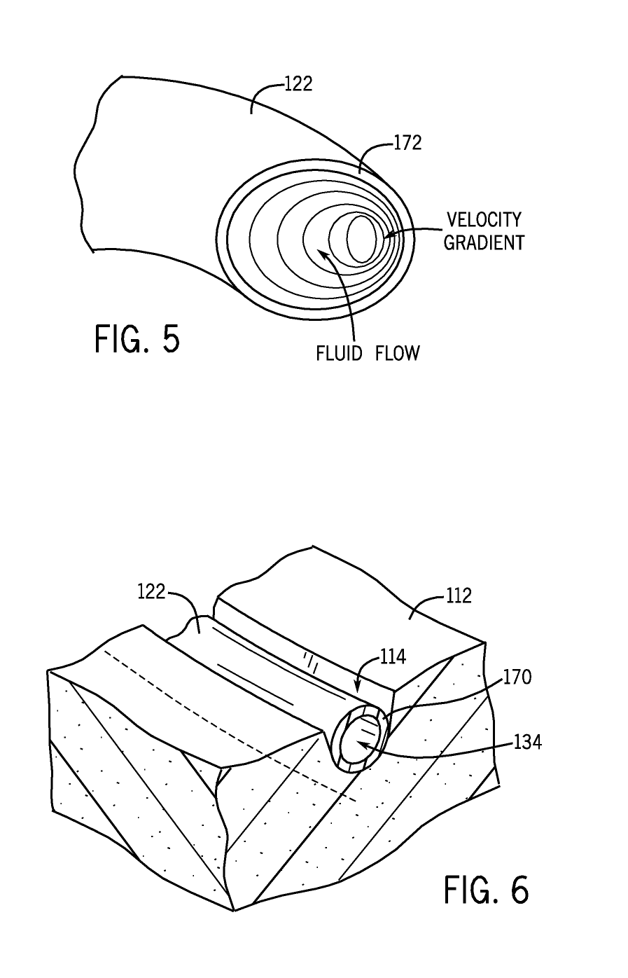

The fluid flow through the tube interior passageway 134 is governed by to which end of the elongated tube 122 the air moving device 166 is coupled. It should be understood, that because of the spiral shape of the elongated tube 122 in the spiral groove 114 there will be velocity gradient of the fluid flow. Such velocity gradient will exhibit a higher velocity at the outside wall of the elongated tube in the particular spiral shape with a lower fluid velocity at the inner wall of the elongated tube. (See FIG. 5). Such velocity gradient is considered in designing the air-tube ventilation system 108 for a specific vehicle seat 100.

The elongated tube 122 can be composed of plastic, rubber, silicon, polyvinylchloride, or any combination of such materials. The size of the tube as well as the tube wall thickness may vary as determined by a particular application as selected by the manufacturer of the air-tube ventilation system 108.

FIGS. 1 and 2 illustrate an exemplary embodiment of a seat pad module 110 that includes the foam cushion member 112 which defines the spiral groove 114. In the illustration, the spiral groove 114 is configured in a substantially circular layout. An elongated tube 122 having an innermost closed end 130 is disposed in the spiral groove 114 and coupled to an air moving device 166 at the innermost end 132.

A spacer fabric pad 154 is positioned above and coupled to the foam cushion member 112. The spacer fabric pad 154 facilitates retention of the elongated tube 122 in the groove 114. The spacer fabric pad 154 is air permeable since the typical fluid flowing through the elongated tube is air.

A heating pad 156 is coupled to the spacer fabric pad 154. The heating pad 156 is of conventional and convenient construction which typically uses a resistive heating coil imbedded in the fabric of the heating pad and may include an air mesh. It should be understood that appropriate power and control wiring associated with the heating pad is coupled to the electrical system and control system of the vehicle in which the vehicle seat 100 is installed.

Air flowing out of the orifices 136 of the elongated tube 122 will pass through the heating pad 156 and into the vehicle interior as part of the air-tube ventilation system 108. It should be understood that in some configurations, the spacer fabric pad 154 and the heating pad 156 can be reversed with the heating pad 156 coupled to the foam cushion member 112 and the spacer fabric pad 154 disposed on top of the heating pad 156.

As mentioned above, and as illustrated in FIG. 1, four seat pad modules 110 can be installed on a vehicle seat 100. As illustrated, an additional seat pad module 160 will be installed on the seat base 104 together with the first seat pad module. A third seat pad module 162 and a fourth seat pad module 164 will be installed on the seat back 102. A perforated seat cover 158 configured to enclose the seat pad modules 110 on both the seat base 104 and the seat back 102 is illustrated in FIG. 1. The seat cover 158 is perforated to allow air flow from the elongated tube 122 to exit the seat into the vehicle interior.

In some configurations, an air permeable foam pad or cushion 159 is included in the perforated seat cover 158. The seat cover can be a perforated nylon, an air permeable leather or other suitable perforated material as determined by the vehicle seat manufacturer and configured to pass the air through the material. The perforated seat cover 158 is shaped and sealed by any convenient and conventional means such as sewing, stapling, sonic welding, etc. as determined by the seat manufacturer and cognizant of the type of material and associated cushioning utilized in a particular seat.

The air-tube seat ventilation system 108 also includes an air moving device 166 which is coupled to the seat pad module 110 and is in fluid communication with one end 126, 130 of the elongated tube 122. In a typical application, the air moving device 166 is disposed beneath the seat frame 106. As illustrated in FIG. 1, one air moving device 166 is positioned beneath the seat base 104 and an optional other air moving device 168 would be positioned behind the seat back 102. The air moving devices 166, 168 can be an air pump or a fan of suitable size and power to move an appropriate air mass (CFM) through the air-tube ventilation system 108. Each of the air moving devices are coupled to the vehicle's electrical power and control systems in a convenient and conventional manner. The seat air-tube ventilation system 108 in some embodiments, is coupled to the vehicle air conditioning system.

In some configurations, the elongated tube 122 is configured with a tube interior passageway 134 reducing from one end 126 of the tube to another end of the tube 130, and in other configurations the elongated tube 122 is configured with one of the innermost end 128 and the outermost end 132 coupled back into the elongated tube 122. (See FIGS. 8A and 8B). Such configurations would be utilized to balance appropriate air pressures and velocity gradients in a seat pad module 110 as determined by the manufacturer of the vehicle seat 100. It is also contemplated that fan noise reduction devices can be utilized as well as appropriate variable speed motors and air filter units associated in conjunction with the air-tube ventilation system 108.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

It may therefore be appreciated from the above detailed description of the preferred embodiment of the present invention that it provides a vehicle seat air-tube ventilation system and method. The vehicle seat air-tube ventilation system and method of the present invention achieves numerous advantages without incurring any substantial relative disadvantage.

Although the foregoing description of the present mechanism has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the mechanism as described herein may be made, none of which depart from the spirit or scope of the present disclosure. The particular embodiments and applications were chosen and described to provide the best illustration of the principles of the mechanism and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be claimed alone or in combination with any of the features, elements, or components of any of the other embodiments discussed above.

What is claimed:

1. A vehicle seat including a seat air-tube ventilation system, the vehicle seat including a seat back and a seat base coupled to a seat frame, the air-tube seat ventilation system comprising:
a seat pad module comprising:
a foam cushion member, the cushion member defining a spiral groove;
an elongated tube disposed in the spiral groove, with the tube defining a plurality of orifices in fluid communication with the tube interior;
a spacer fabric pad coupled to the foam cushion member and configured to facilitate retention of the elongated tube in the groove; and
a heating pad coupled to the spacer fabric; wherein the seat pad module is coupled to one of the seat back and seat base;
a perforated seat cover enclosing the seat pad module; and
an air moving device coupled to the seat pad module and in fluid communication with one end of the elongated tube, with the air moving device disposed beneath the seat frame.

2. The vehicle seat including a seat air-tube ventilation system of claim 1, further comprising at least one additional seat pad module coupled to one of the seat back and seat base, with the one additional seat pad module coupled to the air moving device.

3. The vehicle seat including a seat air-tube ventilation system of claim 2, further comprising a third seat pad module and a fourth seat pad module, wherein two of the seat pad modules are disposed in the seat back and two of the seat pad modules are disposed in the seat base, with each seat pad module coupled to the air moving device.

4. The vehicle seat including a seat air-tube ventilation system of claim 1, wherein the elongated tube is configured in the spiral groove with not less than one and a half turn.

5. The vehicle seat including a seat air-tube ventilation system of claim 1, wherein the elongated tube is configured in the spiral groove with not more than four turns.

6. The vehicle seat including a seat air-tube ventilation system of claim 1, wherein the plurality of orifices in the elongated tube is not less than five nor more than twenty.

7. The vehicle seat including a seat air-tube ventilation system of claim 1, wherein the orifices are configured with a perimeter being one of a circle, an ellipse, a triangle, a tear-drop, an arrow, a cross, and a rectangle.

8. The vehicle seat including a seat air-tube ventilation system of claim 1, wherein the elongated tube defines a cross-section configured as one of a circle, an ellipse, a triangle, and a rectangle.

9. The vehicle seat including a seat air-tube ventilation system of claim 1, wherein the air moving device is one of a pump and a fan.

10. The vehicle seat including a seat air-tube ventilation system of claim 2, further comprising an additional air moving device, with each air moving device coupled to one of the seat pad modules on the seat back and on the seat base.

11. The vehicle seat including a seat air-tube ventilation system of claim 1, wherein the shape of the spiral groove is configured as one of a circle, a triangle, and a rectangle.

12. The vehicle seat including a seat air-tube ventilation system of claim 1, wherein one end of the elongated tube is closed.

13. The vehicle seat including a seat air-tube ventilation system of claim 1, wherein one end of the elongated tube is configured for recirculation of the fluid moving in the tube.

14. The vehicle seat including a seat air-tube ventilation system of claim 1, wherein the elongated tube is configured to couple to the air moving device at one of the innermost end of the elongated tube and innermost end of the elongated tube.

15. The vehicle seat including a seat air-tube ventilation system of claim 1, wherein the elongated tube interior passageway reduces from one end of the tube to another end of the tub.

16. A method for providing heating and ventilating to a vehicle seat, the vehicle seat including a seat base and a seat back both coupled to a seat frame, the method comprising:
installing a seat pad module on one of the seat back and seat base, wherein each seat pad module includes an air dispensing mechanism and a heat dispensing mechanism;
covering each seat pad module on the seat back and seat base with a perforated seat cover configured to enclose each seat pad module; and
coupling an air moving device to each seat pad module configured to provide air to each seat pad module, wherein air and heat moves through the perforated seat cover.

17. The method for providing heating and ventilating to a vehicle seat of claim 16, wherein each seat pad module includes:
a foam cushion member, the cushion member defining a spiral groove;
an elongated tube disposed in the spiral groove, with the tube defining a plurality of orifices in fluid communication with the tube interior;
a spacer fabric pad coupled to the foam cushion member and configured to facilitate retention of the elongated tube in the groove; and
a heating pad coupled to the spacer fabric.

18. The method for providing heating and ventilating to a vehicle seat of claim 16, further comprising providing at least one additional seat pad module coupled to one of the seat back and seat base, with the one additional seat pad module coupled to the air moving device.

19. The method for providing heating and ventilating to a vehicle seat of claim 17, wherein the orifices are configured with a perimeter being one of a circle, an ellipse, a triangle, a tear-drop, an arrow, a cross, and a rectangle.

20. The method for providing heating and ventilating to a vehicle seat of claim 17, wherein the shape of the spiral groove is configured as one of a circle, a triangle, and a rectangle.
